(19) United States
(12) Patent Application Publication
(10) Pub. No.: US 2015/0336665 A1
(43) Pub. Date: Nov. 26, 2015

(54) VTOL aircraft with a thrust-to-weight ratio smaller than 0.08

(71) Applicant: Chen Li Jing, Bougival (FR)

(72) Inventor: Chen Li Jing, Bougival (FR)

(21) Appl. No.: 14/285,462

(22) Filed: May 22, 2014

(51) Int. Cl. B64C 29/00; B64C 15/02; B64C 23/00; B64D 27/20; B64D 35/02; B64C 9/00; B64D 27/02

(52) U.S. Cl. CPC B64C 29/00; B64C 9/00; B64C 15/02; B64D 27/02; B64D 27/20; B64D 35/02; B64C 23/005; B64C 2009/005

(57) ABSTRACT

VTOL aircraft with a thrust-to-weight ratio smaller than 0.08, during vertical take-off/landing, obtains most vertical lift, besides traditional small vertical lift by high-temp bypass slot outlet (6) directing, under its opening, the closing of the tail of the power-off jet engine (3) by the valve (7) in tail cone, the closing and the stretching of the propelling nozzle (5), high-temp air (8) to spout out along the inclined downward direction of the wingspan, by a centrifugal impeller (13) accelerating, under the connecting of the transmission shaft (11) with a jet engine (4), and the opening of the cabin doors (15, 17) of the inlet (18) of the low-temp duct (16) and the auxiliary engine's inlet (14), low-temp air (21) to flow through the low-temp duct (21) and flow over the upper surface of the wing but not burn up it along the wingspan direction, thereby generating most vertical lift and enabling ailerons (1, 2) to control balances of the aircraft.

### BACKGROUND OF THE INVENTION

This invention relates to aircraft, and more particularly, to aircraft with VTOL technology.

Currently, in the traditional VTOL technologies, thrust vectoring technology, such as AV-8, Yak-36 and F-35B, and additional lift engines, such as Yak-38 and Yak-141, in a least efficient way that air doesn't flow over the upper surface of the aircraft but rather over the lower one during vertical take-off/landing, get directly lift from reaction of atmosphere to air jet of jet engine; the use of tilt rotor, such as Boeing's V-22, and rotary wing, such as Boeing's X-50, in a little more efficient way that air both flow over the supper and lower of the aircraft during vertical take-off/landing, get lift from velocity difference of air which both flow the upper and lower surface of aircraft. Because of these limitations, VTOL is impossible for aircraft with thrust-to-weight ratio smaller than 0.08.

### BRIEF SUMMARY OF THE INVENTION

An aircraft to achieve vertical take-off/landing in a much more efficient way that air flows over the upper surface of the aircraft rather than the lower one, the aircraft comprising:
An aileron, which one pair rotate in opposite way for controlling horizontal balance and another pair in one way for controlling vertical balance during vertical take-off/lading, disposed on both sides of the aircraft axis;
A jet engine with an openable/closable and stretchable/shrinkable propelling nozzle being configured, during vertical take-off/landing, to close and stretch for causing high-temp air into a rectangular bypass nozzle, during forward flight, to restore a normal states;
A valve in tail cone being configured, during vertical take-off/landing, to close the tail of power-off jet engine for causing the high-temp air from power-on jet engine into the rectangular bypass nozzle symmetrically, and during forward flight, to restore to normal states;
A rectangular bypass nozzle with height-to-width ratio is smaller than 0.1 being configured, during vertical take-off/landing, to open and spray out high-temp planar jet for generating a part of lift and keeping no airflow on the lower surface of the aircraft, and during forward flight, to restore to normal states;
A lift assembly comprising a shaft coupling, a clutch, a transmission shaft, a gear-box, a centrifugal impeller, an auxiliary duct with a cabin door and a low-temp bypass duct including a cabin door, a round inlet, a stator vane, a rectangle outlet with a height-to-width ratio is smaller than 0.1 and any cross-sectional area of the low-temp bypass duct keeps air less than velocity of sound, the lift assembly being configured, during vertical take-off/landing, in such that the torque of power-on jet engine is transmitted by the shaft coupling, the clutch, a transmission shaft and the gear-box to the centrifugal impeller in case of catching the clutch, air is caused into the auxiliary duct and the low-temp bypass duct from open cabin doors to flow over a round inlet, the centrifugal impeller, the stator vane and the rectangle outlet, form low-temp planar jet on upper surface of the aircraft, thereby generating lift for vertical take-off/landing and power for controlling the vertical and horizontal balances of the aircraft, the lift assembly being configured, during forward flight, to separate the clutch and restore normal states.
   According to the first characteristics of embodiments:
The jet engine, during vertical take-off/landing, closes and stretches the propelling nozzle for causing high-temp air into the rectangular bypass nozzle.
The valve in tail cone, during vertical take-off/landing, closes the tail of power-off jet engine for causing the high-temp air from power-on jet engine into the rectangular bypass nozzle symmetrically.
The rectangular bypass nozzle, during vertical take-off/landing, converts the high-temp air into high-temp planar jet for generating part of lift and keeping no airflow on the lower surface of the aircraft.
The lift assembly, during vertical take-off/landing, causes the airflow in to form low-temp planar jet on upper surface of aircraft for generating most lift efficiently.

### BRIEF DESCRIPTION OF THE DRAWING

The attached drawings illustrate the invention:

FIG. 1 is a side view of an aircraft with this invention during vertical take-off and landing.

FIG. 2 is a top view of an aircraft with this invention during vertical take-off and landing.

FIG. 3 is a rear view of an aircraft with this invention during vertical take-off and landing.

FIG. 4 is A-A Section for FIG. 2.

FIG. 5 is part Section for FIG. 2.

FIG. 6 is B-B Section for FIG. 2.

FIG. 7 is a side view of an aircraft with this invention during forward flight.

FIG. 8 is a top view of an aircraft with this invention during forward flight.

FIG. 9 is a rear view of an aircraft with this invention during forward flight.

FIG. 10 is C-C Section for FIG. 8.

FIG. 11 is part Section for FIG. 8.

FIG. 12 is D-D Section for FIG. 8.

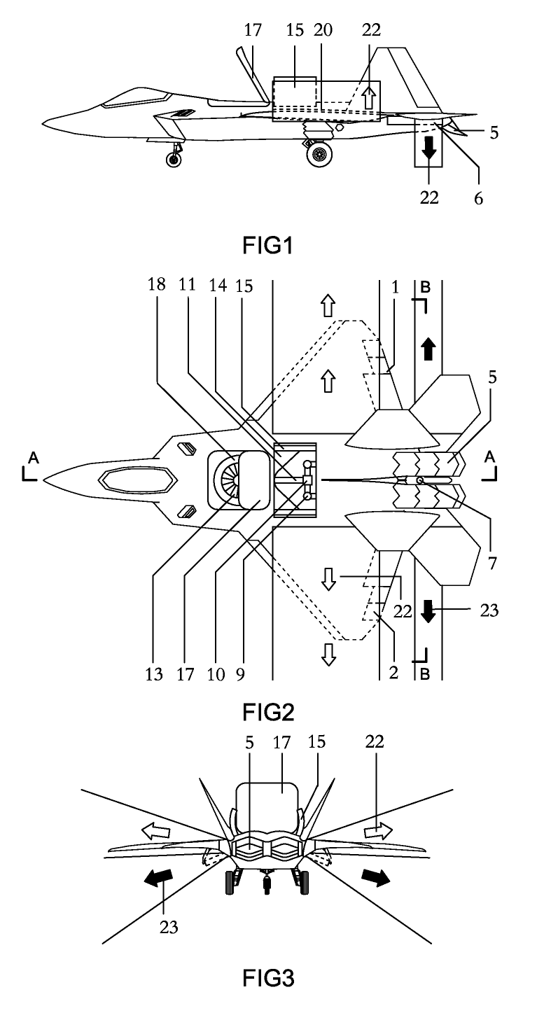

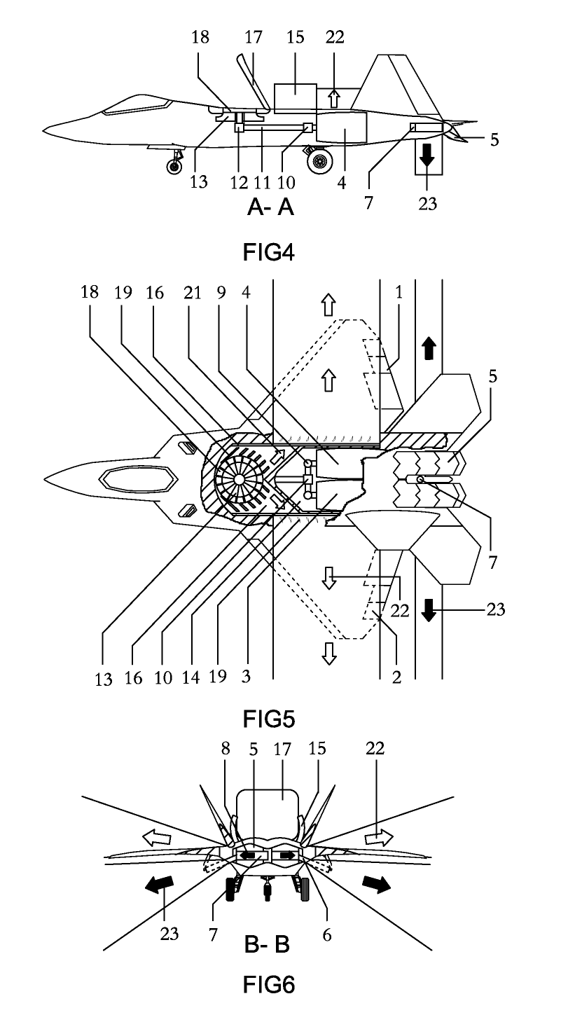

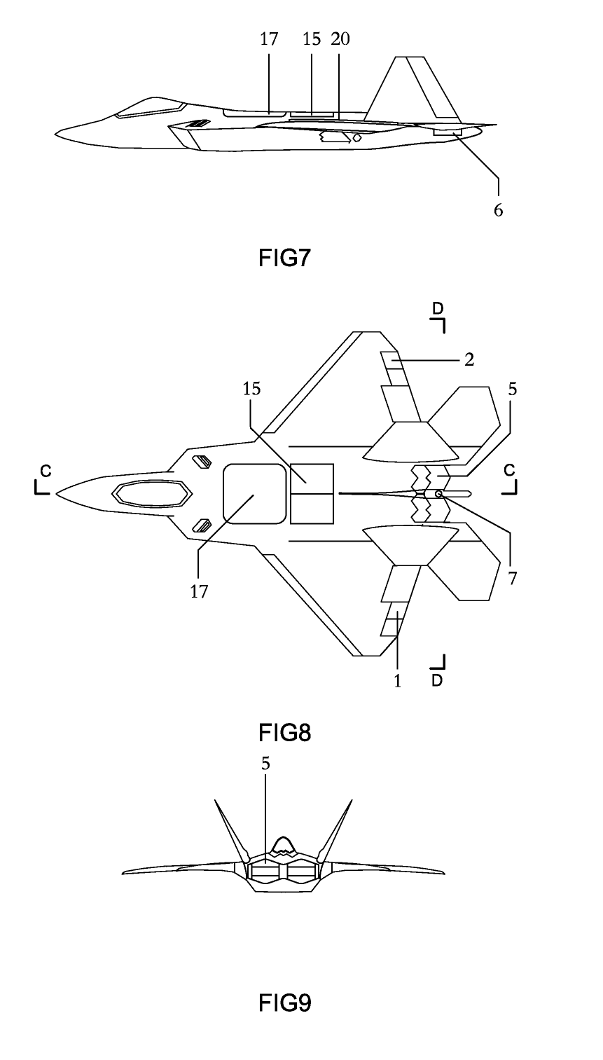

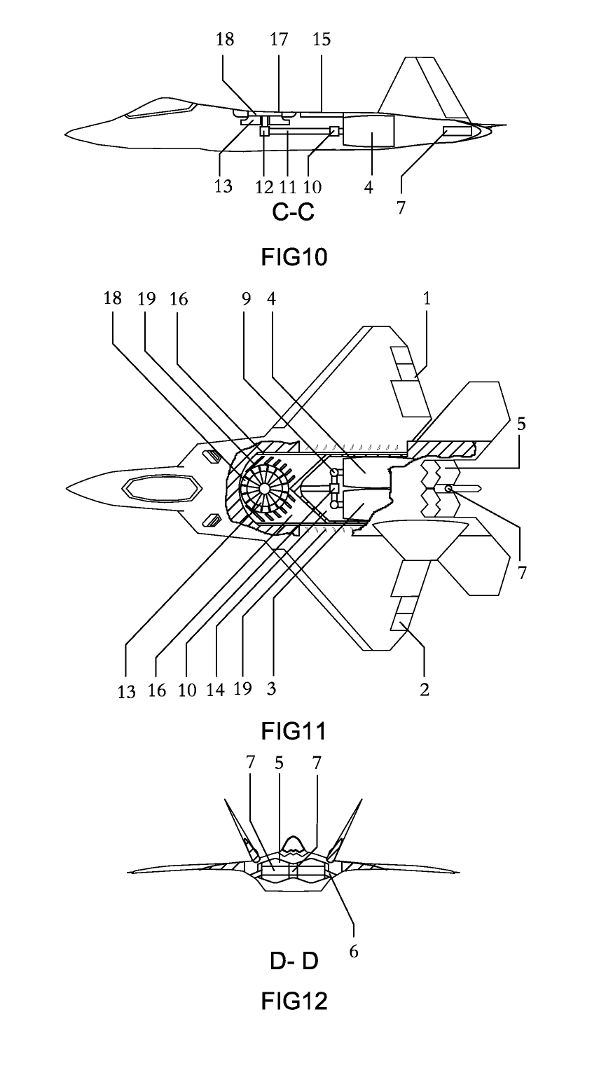

### DETAILED DESCRIPTION OF THE INVENTION

Referring to these drawings, the aircraft comprising: an aileron (1, 2) which one pair (1) rotate in opposite way and another pair (2) rotate in one way; a jet engine (3,4) with a propelling nozzle (5) that is openable/closable and stretchable/contractible; a rectangle bypass nozzle (6), which height-to-width ratio is smaller than 0.1 and openable/closable; a valve in tail cone (7), which closes the tail of power-off jet engine (3) and to causes the high-temp air (8) from the power-on jet engine (4) into the rectangle bypass nozzle (6) symmetrically; a lift assembly comprising a shaft coupling (9), a clutch (10), a transmission shaft (11), a gear-box (12), a centrifugal impeller (13), an auxiliary duct (14) with a cabin door (15) and a low-temp bypass duct (16) including a cabin door (17), a round inlet (18), a stator vane (19), a rectangle outlet (20) with a height-to-width ratio is smaller than 0.1 and any cross-sectional area of the low-temp bypass duct (16) keeps air less than velocity of sound.

Referring to FIG. (1-6), the innovative combination being configured, during vertical take-off/lading, to close propelling nozzle (5) of the jet engine (3,4); open cabin door (15) of the auxiliary duct (14), cabin door (17) of the low-temp bypass duct (16) and the valve in tail cone (7), and catch the clutch (10); torque of power-on jet engine (4) is transmitted by the shaft coupling (9), the clutch (10), the transmission shaft (11) and the gear-box (12) to the centrifugal impeller (13); air (21) is caused into the auxiliary duct (14) and the low-temp bypass duct (16) from open cabin doors (15,17) to flow through a round inlet (18), the centrifugal impeller (13), the stator vane (19) and the rectangle outlet (20), form low-temp planar jet (22) on upper surface of the aircraft, thereby generating lift for vertical take-off/landing and power for controlling the vertical and horizontal balances of the aircraft; high-temp air (8), generated by the jet engine, flows through the opened valve in tail cone (7) and rectangle bypass nozzle (6) with a height-to-width ratio smaller than 0.1 to spray high-temp planar jet (23) for generating part of life and keeping no air on lower surface of the aircraft.

Referring to FIG. (7-12), the innovative combination being configured, during forward flight, to separate the clutch (10) and restore normal states in order that high-temp air (17) sprays directly into atmosphere from the open thrust vector nozzle of the jet engine.

All the formulas and calculations for this invention are listed in Annex 1.

All the formulas and calculations used to retrofit an F-22 based on this invention are listed in Annex 2.

This invention can be used to retrofit and existing aircraft to achieve VTOL or manufacture a VTOL aircraft with a thrust-to-weight ratio smaller than 0.08.

ANNEX 1

| | | |
|---|---|---|
| P | Atmospheric pressure | (Unit: Pa) |
| R | Ideal gas constant | (Unit: |
| | | J · K⁻¹ · mol⁻¹) |
| ρ₀ | Low-temp jet density at the outlet | (Unit: kg/m³) |
| ρ₁ | Atmospheric density | (Unit: kg/m³) |
| ρ | Jet density on the cross-section | (Unit: kg/m³) |
| ρₘ | Jet density of the shaft | (Unit: kg/m³) |
| T₀ | Jet temp at the low-temp outlet | (Unit: K) |
| T₁ | Atmospheric temp | (Unit: K) |
| T | Jet temp on the cross-section | (Unit: K) |
| V₀ | Jet speed at the outlet of low-temp bypass duct | (Unit: m/s) |
| V₀′ | Jet speed at the outlet of high-temp bypass duct | (Unit: m/s) |
| V | Jet speed on the cross-section | (Unit: m/s) |
| Vₘ | Jet speed of shaft | (Unit: m/s) |
| h₀ | Jet height of the outlet | (Unit: m) |
| hₘ | Jet height of the cross-section | (Unit: m) |
| h | Jet height on the cross-section | (Unit: m) |
| L | Width of the outlet | (Unit: m) |
| C | Gas specific volume | (Unit: m³/kg) |
| M | Molar mass | (Unit: kg/mol) |
| Q₁ | Air inflow of jet engine | (Unit: kg/s) |
| Q₂ | Air inflow of jet engine | (Unit: kg/s) |
| G | Maximum take-off weight | (Unit: T) |
| X | Distance between any point and outlet | (Unit: m) |
| | of low-temp bypass duct in jet direction | |
| X₁ | Distance between wing root and crossing of jet | (Unit: m) |
| | boundary and leading edge of wing in jet | |
| | direction | |
| X₂ | Distance between wing root and crossing of jet | (Unit: m) |
| | boundary and trailing edge of wing in jet direction | |
| X₃ | Distance between wing root and wing tip | (Unit: m) |
| | in jet direction | |
| α | Angle between jet boundary and leading edge | (Unit: °) |
| | of wing | |
| β | Angle between jet boundary and second trailing | (Unit: °) |
| | edge of wing | |
| Ø | Included angle between axis of high-temp planar | (Unit: °) |
| | jet and horizontal plane | |
| F | Total vertical lift | (Unit: T) |
| F₁ | Lift on the wing when 0 < X ≦ X₁ | (Unit: T) |
| F₂ | Lift on the wing when X₁ < X ≦ X₂ | (Unit: T) |
| F₃ | Lift on the wing when X₂ < X ≦ X₃ | (Unit: T) |
| F₄ | Lift generated by rectangular bypass nozzle | (Unit: T) |
| F₅ | Thrust generated by lift assembly | (Unit: T) |
| F₆ | Thrust generated by rectangular bypass nozzle | (Unit: T) |
| n₁ | S/N of jet engine | (Dimensionless |
| | | unit) |
| n₂ | S/N of jet engine used in vertical take-off/landing | (Dimensionless |
| | | unit) |
| TWR | Thrust-to-weight ratio of aircraft | (Dimensionless |
| | | unit) |

And according to the feature of planar jet, it just spread on the flat which is perpendicular to the outlet section.

$$P = \frac{{ρ}_{0}}{M} {RT}_{0} = \frac{{ρ}_{1}}{M} {RT}_{1} = \frac{ρ}{M} RT$$

Because of:

### T₀=T₁=T

ρ₀=ρ₁=ρ

And according to the similarity of velocity and density distribution on the various jet sections,

$$\sqrt{\frac{V}{{V}_{m}}} = 1 - {( \frac{h}{{h}_{m}} )}^{1.5}$$

According to dynamic characteristic of jet, momentum of the various sections, in the case of equal pressure, is same.

$${ρ}_{0} {Lh}_{0} {V}_{0}^{2} = {\int }_{0}^{{h}_{m}} ρ {LV}^{2} d h \\ {h}_{0} {V}_{0}^{2} = {\int }_{0}^{{h}_{m}} {V}^{2} d h \\ \frac{{V}_{0}^{2}}{{V}_{m}^{2}} = {\int }_{0}^{1} \frac{{V}^{2} {h}_{m}}{{V}_{m}^{2} {h}_{0}} d ( \frac{h}{{h}_{m}} ) \\ {V}_{m} = {V}_{0} \cdot \sqrt{\frac{12}{7} \cdot \frac{{h}_{0}}{{h}_{m}}} \qquad ( 1 )$$

When X≦X₁

$${F}_{1} = p - ( P - \frac{1}{2} \int {ρ}_{m} {V}_{m}^{2} L d x ) = \frac{1}{2} \int {ρ}_{m} {V}_{m}^{2} L d x = \frac{1}{2} \int {ρ}_{0} {V}_{m}^{2} L d x \qquad ( 2 )$$

Substitute (1) into (2)

$${F}_{1} = \frac{1}{2} {\int }_{0}^{{X}_{1}} \frac{12}{7} {ρ}_{0} \cdot \frac{{h}_{0}}{{h}_{m}} {V}_{0}^{2} L d x$$

Because of

$$\frac{{h}_{m}}{{h}_{0}} = 2.44 \cdot ( \frac{0.12 X}{{h}_{0}} + 0.41 ) \\ \begin{matrix}{F}_{1} = \frac{1}{2} {\int }_{0}^{{X}_{1}} \frac{\frac{12}{7}}{\sqrt{2.44 \times ( \frac{0.12 X}{{h}_{0}} + 0.41 )}} \times {ρ}_{0} {V}_{0}^{2} L d x \\ = {[ \frac{12 {ρ}_{0} {V}_{0}^{2} {h}_{0} L}{7 \times 2.44 \times 0.12} \cdot \sqrt{2.44 \times ( \frac{0.12 X}{{h}_{0}} + 0.41 )} ]}_{0}^{{X}_{1}}\end{matrix} \qquad ( 3 )$$

When X₁<X≦X₂

$$\begin{matrix}{F}_{2} = \frac{1}{2} {\int }_{{X}_{2}}^{{X}_{1}} \frac{\frac{12}{7}}{\sqrt{2.44 \times ( \frac{0.12 X}{{h}_{0}} + 0.41 )}} \times {ρ}_{0} {V}_{0}^{2} \times \\ [ L - ( x - {X}_{1} ) \times tan α ] d x \\ = \{ \frac{12 {ρ}_{0} {V}_{0}^{2} {h}_{0} [ L + ( {X}_{1} - x ) \cdot tan α ] \sqrt{2.44 \times ( \frac{0.12 X}{{h}_{0}} + 0.41 )}}{7 \times 2.44 \times 0.12} + \\ { \frac{2 \times 12 \times {ρ}_{0} {V}_{0}^{2} \times {h}_{0}^{2} \times tan {α [ 2.44 \times ( \frac{0.12 X}{{h}_{0}} + 0.41 ) ]}^{\frac{3}{2}}}{3 \times 7 \times {( 2.44 \times 0.12 )}^{2}} \}}_{{X}_{2}}^{{X}_{1}}\end{matrix} \qquad ( 4 )$$

When X₂<X≦X₃

$$\begin{matrix}{F}_{3} = \frac{1}{2} {\int }_{{X}_{3}}^{{X}_{2}} \frac{\frac{12}{7}}{\sqrt{2.44 \times ( \frac{0.12 X}{{h}_{0}} + 0.41 )}} \times {ρ}_{0} {V}_{0}^{2} \times [ L - ( x - {X}_{2} ) \times ( tan α + tan β ) ] d x \\ = \{ \frac{12 {ρ}_{0} {V}_{0}^{2} {h}_{0} [ L + ( {X}_{2} - x ) \cdot ( tan α + tan β ) ] \sqrt{2.44 \times ( \frac{0.12 X}{{h}_{0}} + 0.41 )}}{7 \times 2.44 \times 0.12} + \\ { \frac{2 \times 12 \times {ρ}_{0} {V}_{0}^{2} \times {h}_{0}^{2} \times {( tan α + tan β ) [ 2.44 \times ( \frac{0.12 X}{{h}_{0}} + 0.41 ) ]}^{\frac{3}{2}}}{3 \times 7 \times {( 2.44 \times 0.12 )}^{2}} \}}_{{X}_{2}}^{{X}_{1}}\end{matrix} \qquad ( 5 )$$

When the rectangular bypass nozzle sprays out high-temp planar jet,

$$\begin{matrix}{F}_{4} = \frac{1}{2} {QV}_{0}^{′} sin ∅ & ( 6 ) \\ F = 2 ( {F}_{1} + {F}_{2} + {F}_{3} + {F}_{4} ) & ( 7 )\end{matrix}$$

VTOL can be achieved once: F>G

### ANNEX 2

n₁=1˜2
n₂=1
Q₁ (Air inflow of F119-PW-100 jet engine)=150 kg/s
Q₂ (Air outflow of the centrifugal impeller)=100 kg/s
G (Maximum take-off weight of F22)=38 T
ρ₀=ρ₁=ρ=1.293 kg/m²

Assuming:

$$\begin{matrix}α = 41.5 ° \\ β = 41.5 ° \\ ∅ = 45 ° \\ {h}_{0} = 0.06 m \\ L = 5 m \\ {V}_{0} = \frac{\frac{1}{{n}_{2}} \times {Q}_{2}}{{ρ}_{0} \times L \times {h}_{0}} = \frac{\frac{1}{2} \times 90}{1.293 \times 5 \times 0.04} = 174 m \text{/} s \\ {V}_{0}^{′} = 261 m \text{/} s {F}_{4} = \frac{1}{2} {QV}_{0}^{′} sin ∅ = \frac{1}{2} \times 150 \times 261 \times sin 45 ° = 13841.6152 N = 1.4 T \\ {F}_{5} = \frac{1}{2} {QV}_{0} = \frac{1}{2} \times 90 \times 174 = 7830 = 0.8 T \\ {F}_{6} = \frac{1}{2} {QV}_{0}^{′} = \frac{1}{2} \times 150 \times 261 = 19575 N = 2 T \\ {X}_{1} = 1.87 m \\ {X}_{2} = 4 m \\ {X}_{3} = 5 m \\ & \\ \begin{matrix}{F}_{1} = \frac{12 \times 1.293 \times {174}^{2} \times 0.04 \times 5}{7 \times 2.44 \times 0.12} \cdot ( \sqrt{2.44 \times ( \frac{0.12 \times 1.87}{{h}_{0}} + 0.41 )} - \sqrt{2.44 \times 0.41} ) \\ = 129835.449 N \\ = 13 T\end{matrix} & ( 5 ) \\ \begin{matrix}{F}_{2} = \{ \frac{12 \times 1.293 \times {174}^{2} \times 0.04 \times [ 5 + ( 1.87 - x ) \cdot tan 41.5 ° ] \sqrt{2.44 \times ( \frac{0.12 X}{{h}_{0}} + 0.41 )}}{7 \times 2.44 \times 0.12} + \\ { \frac{2 \times 12 \times 1.293 \times {174}^{2} \times {0.04}^{2} \times tan 41.5 {° [ 2.44 \times ( \frac{0.12 X}{0.04} + 0.41 ) ]}^{\frac{3}{2}}}{3 \times 7 \times {( 2.44 \times 0.12 )}^{2}} \}}_{1.87}^{4} \\ = \{ 9167.8848 \times [ 5 + ( 1.87 - x ) \times tan 41.5 ° ] \sqrt{2.44 \times ( \frac{0.12 X}{0.04} + 0.41 )} + \\ { {738.7121 [ 2.44 \times ( \frac{0.12 X}{{h}_{0}} + 0.41 ) ]}^{\frac{3}{2}} \}}_{1.87}^{4} \\ = 62992.4627 N \\ = 6.4 T\end{matrix} & ( 6 ) \\ \begin{matrix}{F}_{3} = \{ \frac{12 \times 1.293 \times {174}^{2} \times 0.04 \times [ 5 + ( 4 - x ) \cdot ( tan 41.5 ° + tan 41.5 ° ) ] \sqrt{2.44 \times ( \frac{0.12 X}{{h}_{0}} + 0.41 )}}{7 \times 2.44 \times 0.12} + \\ { \frac{2 \times 12 \times \times 1.293 \times {174}^{2} \times {0.04}^{2} {( tan 41.5 ° + tan 41.5 ° ) [ 2.44 \times ( \frac{0.12 X}{{h}_{0}} + 0.41 ) ]}^{\frac{3}{2}}}{3 \times 7 \times {( 2.44 \times 0.12 )}^{2}} \}}_{4}^{5} \\ = \{ 9167.8848 [ 5 + 2 \times ( 4 - x ) \cdot tan 41.5 ° ] \sqrt{2.44 \times ( \frac{0.12 X}{{h}_{0}} + 0.41 )} + \\ { {1307.1145 [ 2.44 \times ( \frac{0.12 X}{{h}_{0}} + 0.41 ) ]}^{\frac{3}{2}} \}}_{4}^{5} \\ = 12939.8827 N \\ = 1.3 T\end{matrix} & ( 7 )\end{matrix}$$

According to this sweep forward angle, low-temp planar jet can keep balances during vertical take-off/landing.

$$\begin{matrix}\begin{matrix}F = 2 ( {F}_{1} + {F}_{2} + {F}_{3} + {F}_{4} ) \\ = 2 ( 13 + 6.4 + 1.3 + 1.4 ) \\ = 44.2 T\end{matrix} & ( 9 ) \\ F - G = 44.2 - 38 = 6.2 T > 0 \\ TWR = \frac{{n}_{2} ( {F}_{5} + {F}_{6} )}{G} = \frac{0.8 + 2}{38} = 0.07 < 0.08 & ( 10 )\end{matrix}$$

It is clearly demonstrated above that VTOL is achievable on F-22 once remodeled as shown, and more particularly, in case of using just one jet engine and thrust-to-weight ratio smaller than 0.08.

1. An aircraft capable of vertical take-off/landing, comprising: ailerons (1, 2); an auxiliary engine's inlet (14) with an openable/closable cabin door (15); a transmission shaft (11) comprising a clutch (10) connectable/separable to a jet engine (3, 4), a shaft coupling (9) and a gear-box (12); an low-temp duct (16) comprising an inlet (18) with an openable/closable cabin door (17), stator vanes (19) and a thin slot outlet (20) set on the upper surface of the wing in the direction of the wingspan; a centrifugal impeller (13) in which a bottom end connects with the gear-box (12); a valve (7) in tail cone; an openable/closable high-temp bypass slot outlet (6); a jet engine (3, 4) with an openable/closable and stretchable/shrinkable propelling nozzle (5).

2. The aircraft according to claim 1 wherein the centrifugal impeller (13), during vertical take-off/landing, accelerates, under the opening of the cabin doors (15, 17) of the inlet (18) of the low-temp duct (16) and the auxiliary engine's inlet (14) and the connecting of the transmission shaft (11) with a jet engine (4), low-temp air (21) taken by itself to flow through the low-temp duct (16) and flow, in form of low-temp planar jet (22), over the upper surface of the wing in the direction of the wingspan, thereby generating most vertical lift and enabling ailerons to control horizontal and vertical balances of the aircraft.

3. The aircraft according to claim (1) 1-2 wherein the high-temp bypass slot outlet (6), during vertical take-off/landing, directs, under its opening, the closing and the stretching of the propelling nozzle (5) and the closing of the tail of the power-off jet engine (3) by the valve (7) in tail cone, high-temp air (8) to spout, in form of high-temp planar jet (23), out along the inclined downward direction of the wingspan, thereby generating small vertical lift.

4. The aircraft according to claim (1) 1-3 wherein the propelling nozzle (5), during forward flight, spouts out high-temp air (8) directly under its opening and the shrinking, the closing of the cabin doors (15, 17) of the inlet (18) of the low-temp duct (16) and the auxiliary engine's inlet (14), the opening of the tail of the power-off jet engine (3) by the valve (7) in tail cone and the separating of the transmission shaft (11) from the jet engine (4).

5. (canceled)
